(19) United States
(12) Patent Application Publication
(10) Pub. No.: US 2008/0018063 A1
(43) Pub. Date: Jan. 24, 2008

(54) Device for towing a trolley

(76) Inventor: Prince Morowat, Aurora (CA)

Correspondence Address: SIM & MCBURNEY, 330 UNIVERSITY AVENUE, 6TH FLOOR, TORONTO, ON, M5G 1R7, US

(21) Appl. No.: 11/481,905

(22) Filed: Jul. 7, 2006

(51) Int. Cl. B62D 51/04

(52) U.S. Cl. 280/1.5

(57) ABSTRACT

A device for towing a trolley includes a rigid shaft having a proximal end and a distal end. A user-releasable clamp is associated with the distal end and is dimensioned to grip a handle of the trolley. A user-releasable coupler is associated with the proximal end for coupling the device to a user. Both the clamp and the coupler being user-releasable provides great flexibility for use with a wide variety of trolleys and for ease of storage.

### FIELD OF THE INVENTION

The methods and systems disclosed herein relate generally to devices and arrangements for towing, and more particularly to a device for towing a trolley such as a golf cart, luggage or the like over the ground.

### BACKGROUND OF THE INVENTION

Golf carts of various types are well-known and widely used by golfers for transporting golf bags with clubs and accessories to and from the clubhouse, over the golf course and so forth. Typically during use, a golfer reaches back to grasp the handle of the cart and pull the golf cart along. Doing so, however, puts strain on the golfer's shoulder, forearm and wrist. Furthermore, in order to reach back and pull the cart, the golfer must have a free hand. After a shot but prior to pulling the cart, the golfer must therefore have to take the time to clean his golf club and place it back in the golf bag, or carry the club with his other free hand.

Often, a golfer will also want to remove his gloves, mark a scorecard, have a drink of some beverage, or undertake some other related activity between shots on the course. As such, the golfer must either perform these activities prior to pulling the cart, or afterwards, as each typically require the use of both hands in some capacity.

U.S. Pat. No. 5,244,217 to Kotulla discloses a golf car pulling device that comprises a strap-like device detachably attached to the handle of the golf cart. A large loop in the strap extends from the handle of the golf cart over the shoulder of the golfer. This device is somewhat of an improvement because it leaves the hands of the golfer free to, for example, mark a scorecard. However, when going downhill the cart will not be prevented by the strap from rolling faster than the golfer, will be difficult to control and will likely collide with the golfer.

U.S. Pat. No. 6,431,556 discloses a golf cart towing device that is attached along a tongue of a golf cart and adjustable to fit cart tongues of various breadth. A connector rod is angularly adjustable relative to the handle and includes a hook end for engaging an eyelet extending from a belt worn by the golfer. A releasable latch on the hook end maintains the hook end within the eyelet. The device is described as selectably attached to the golf cart tongue, but its installation on the golf cart is actually a complex procedure requiring the careful positioning of several small pieces using trial and error.

U.S. Pat. No. 6,131,917 to Walsh discloses a towing device for a golf trolley which comprises a longitudinal resilient linkage means either incorporated in the golf trolley handle or selectively attachable thereto. In its attachable form, a connecting device comprising a bracket is secured to golf trolley using a wing nut securing bolt. An arm extends from the bracket which has a plate containing a hole. The plate fits into the bracket on the towing device, and a pin is then inserted through the bracket and the plate to thereby secure the towing device to the golf trolley.

U.S. Pat. No. 3,328,043 to Johnson discloses a golf cart coupling apparatus which includes a substantially vertical post member which is rigidly secured to the end of a straight handle of the golf cart by means of a clamp. The clamp comprises two semicircular members secured about the handle by means of nut and bolt assemblies. A first coupling member in the form of a bent metal rod has a cylindrical coupling section which receives the vertical post member and holds it into place by a wing nut and bolt passed through the cylindrical coupling section and one of three horizontal holes on the post. The other end of the first coupling member is bent and may be selectively inserted into a mating, second coupling member attached to the golfer's belt.

U.S. Pat. No. 2,559,981 to McBride discloses a towing device for golf bags and the like which is attached to the golf cart using a wooden screw/plug combination, or clamped to the handle using a wing nut and bolt combination. A hook extends away from the golf cart and is adapted to be releasably inserted into a holster on the belt of the golfer.

U.S. Pat. No. 3,926,448 to Reichard discloses a golf cart pulling apparatus having connecting means comprising a belt to be worn by the user. The connecting means is permanently connected to the golf cart and there is no other handle.

U.S. Pat. No. 4,236,723 to Lemmon discloses a complex hip cart for carrying a load. A strap is located at a proximal end of arms that extend from the cart, and is used as a belt to couple the hip cart to a user.

U.S. patent application Ser. No. 2001/0040350 to Allen et al. discloses a golf bag cart handle assembly for enabling a golfer to push a golf cart. The handle wraps around at least a portion of the golfer's body and presents the golfer with horizontal and vertical gripping positions directly in front of the golfer. The handle comprises a connecting assembly and a height adjusting assembly. The connecting assembly is generally permanently attached to the golf cart and may be detached from the height adjusting assembly.

The above-described configurations are each attached rather permanently to the golf cart or trolley, such that removal or adjustment between uses is not generally practical. Many of the configurations, once installed, completely convert the golf cart such that the user is forced to employ the towing devices at all times because the handle is blocked in some manner. These configurations, while useful in some situations, accordingly curtail the ability of the user to navigate the golf cart ny hand in a conventional manner.

U.S. Pat. No. 6,978,485 to Stude discloses a simple two-loop device for receiving both a golfer's belt and an open-ended handle of a golf cart. A golfer is able to insert and retain the open-ended handle into one of the loops and pull the golf cart hands-free.

U.S. Pat. No. 5,215,318 to Capraro discloses a body cart comprising a towing mechanism. The towing mechanism comprises an elongated arm locked onto the bottom of the housing of the cart, and bent at its opposite end to provide a handle. The handle may be removably inserted into a sleeve on the user's belt buckle.

U.S. Pat. No. 5,622,294 to Evans and U.S. Patent Application Publication No. 2005/0115998 to Swenson each disclose towing belts suitable for receiving an open-ended bent handle of a golf cart so as to enable a user to tow the golf cart hands-free.

U.S. Pat. No. 3,311,385 to Frantz discloses a golf cart pulling device attachable to a user's belt for receiving and retaining an open-ended straight handle of a golf cart. A planar member is attached to the user's belt. A handle-engaging member comprising a shaped rigid loop extends from the planar member and receives and engages the open-ended straight handle.

While a number of the devices described above provide advantages, many are not suitable for use with closed-ended, bent handle golf carts. Several require direct contact between the golf cart handle and the user's belt, and therefore rely on the handle itself to be of such a length that the user's heels when walking do not interfere with the cart. However, many golf carts have been designed based on the assumption that a user's arm provides the extension required to prevent such interference. Other ones of the devices described above are not user-detachable from the cart itself, and therefore require significant time on the part of the golfer to de-install when necessary or are otherwise left on the carts, interfering with the ability of the user to pull the cart using an arm in the conventional manner. Furthermore, many of the devices are not adjustable to as to compensate for the varying heights and statures of the intended users.

It is an object of an aspect of the following to provide a novel device for towing a personal trolley or like device that obviates or at least mitigates the above disadvantages.

### SUMMARY OF THE INVENTION

According to one aspect there is provided a device for towing a trolley comprising:

a rigid shaft having a proximal end and a distal end;

a user-releasable clamp associated with the distal end, the clamp dimensioned to grip a handle of the trolley; and

a user-releasable coupler associated with the proximal end for coupling the device to a user.

According to an embodiment, the shaft has an adjustable length.

According to another embodiment, the user-releasable clamp is selectively adjustable between a clamping position and a release position.

The device provides advantages over prior art devices in that it is easily releasable by a user from the trolley in addition to being releasable from coupling with the user. The device is therefore more suitable as part of the user's set of golfing accessories for selective rather than required use. A clubhouse need not undertake significant installment of the device on trolleys prior to use by a golfer, since the device is easily clamped to the golf cart by the user when desired without tools. Furthermore, since the device is user-releasably clamped to a trolley handle and not permanently attached, the device may be more universally used by its owner for towing luggage or other similar items.

The rigid shaft provides increased control over the trolley than do prior art devices employing a strap. Embodiments of the invention having an adjustable shaft length enable the device to be more universally used with various configurations of trolleys, and sizes and statures of users.

Embodiments in which the user-releasable clamp retains the handle in a position intermediate the clamping and release positions provides flexibility for use. For example, in the intermediate position, the device could be left to “dangle” from the handle, making the golf cart easier to store, or making it easier for the golfer to pull the trolley using his arm in a conventional manner where desired.

### BRIEF DESCRIPTION OF THE DRAWINGS

Embodiments will now be described more fully with reference to the accompanying drawings, in which:

FIG. 1 is a perspective view of a user towing a golf trolley with a towing device according to one embodiment;

FIG. 2 is a perspective view of the towing device separated from the user and gripping a handle of the golf trolley;

FIG. 3 is an elevational partial view of the user-releasable clamp of the towing device gripping the handle of the golf trolley;

FIG. 4 is a partial cross-sectional view of a collar in cooperation with a split shaft portion of the user-releasable clamp;

FIG. 5 is a perspective view of user-side and shaft-side portions of the user-releasable coupler of the towing device; and

FIG. 6 is an elevational view of the user-side portion of the user-releasable coupler.

### DETAILED DESCRIPTION OF THE EMBODIMENTS

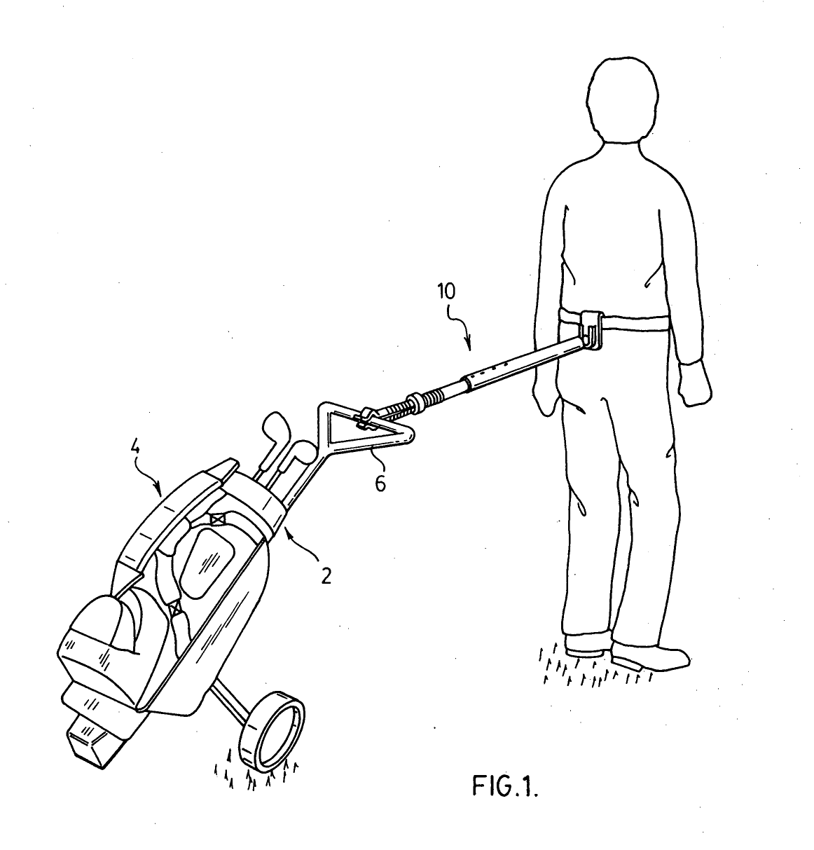

FIG. 1 is a perspective view of a user towing a golf trolley 2 with a towing device 10 according to an embodiment of the invention. Golf trolley 2 supports a golf bag 4 in a well-known manner. Device 10 is clamped to handle 6 and coupled to the clothing of the user, thereby enabling the user to tow golf trolley 2 without having to extend his arm behind him. Device 10 is easily released by the user both from handle 6 and the user. Because device 10 is user-releasable from golf trolley 2, device 10 may be used without installing any parts on golf trolley 2, such that golf trolley 2 remains unaltered.

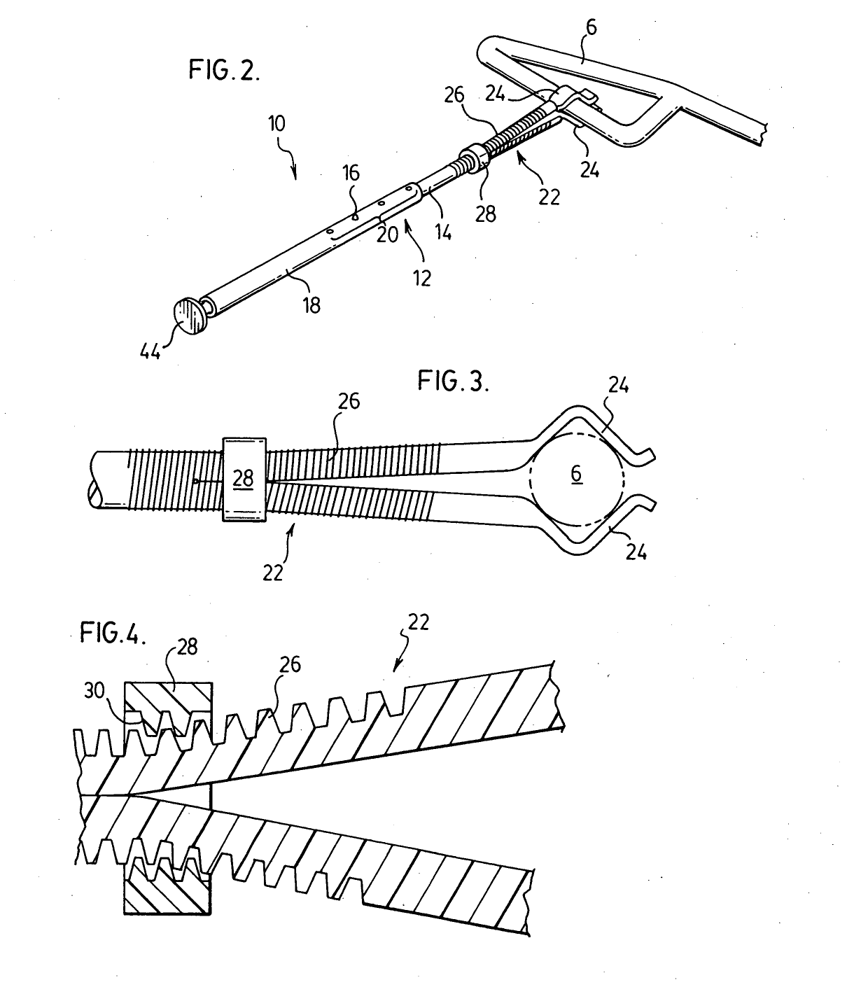

FIG. 2 is a perspective view of towing device 10 having been de-coupled from the user, but still gripping handle 6 of golf trolley 2. Towing device 10 includes a shaft 12 having a rod portion 14 and a tube portion 18. Rod portion 14 has a slightly smaller outer diameter than the inner diameter of tube portion 18 so as to be receivable by and slidable within tube portion 18. Rod portion 14 includes a ball-bearing spring lock 16 biased to a protruding position and movable between the protruding position and a recessed position. In the protruding position, ball-bearing spring lock 16 can partially extend through one of a series of holes 20 in tube portion 18. The user adjusts the length of shaft 12 as desired by pushing on ball-bearing spring lock 16 from the exterior of tube portion 18 so as to cause ball-bearing spring lock 16 to recede from its current hole in tube portion 18. The user then slides rod portion 14 relative to tube portion 18 until ball-bearing spring lock 16 aligns with another hole. Pressure on ball-bearing spring lock 16 is then released, causing it to partially extend through the new hole thereby to prevent further sliding of rod portion 14 within tube portion 18.

Device 10 includes a user-releasable clamp 21 at a trolley (distal) end of shaft 12 and a user-releasable coupler 32 at a user (proximal) end of shaft 12. FIG. 3 is an elevational partial view of a user-releasable clamp 21 of towing device 10 on a trolley (distal) end of shaft 12 gripping handle 6 of golf trolley 2. User-releasable clamp 21 comprises a flexible split shaft portion 22 terminating in a pair of jaws 24. Split shaft portion 22 is received within a collar 28. Collar 28 is movable along split shaft portion 22 by virtue of its internal threads 30 mating with external threads 26 of split shaft portion 22. Depending upon direction of rotation of collar 28 relative to split shaft portion 22, collar 28 moves either towards or away from the trolley (distal) end of shaft 12. Progressive movement of collar 28 towards jaws 24 causes the two sides of flexible split shaft portion 22 to converge from a release position, thereby causing jaws 24 to cooperate to first retain and eventually move to a clamping position to clamp handle 6. Progressive movement of collar 28 away from jaws 24 releases the two sides of flexible split shaft from convergence. Jaws 24 may thereby be moved apart from the clamping position first enough to reduce the clamping force and eventually to a release position to release handle 6 altogether. If the two sides of flexible split shaft portion 22 are biased such that they naturally tend to the release position in which they are far apart, then it will be understood that progressive movement of collar 28 away from jaws 24 will permit the two sides to diverge under their natural bias until they reach the release position. Otherwise, the user can manually separate the two sides of flexible split shaft portion 22.

FIG. 4 is a partial cross-sectional view of both collar 28 and flexible split shaft portion 22 in cooperation via threads 26 and 30. As has been described above, movement of collar 28 to the right would cause the two sides of flexible split shaft portion 22, biased apart, to converge jaws 24.

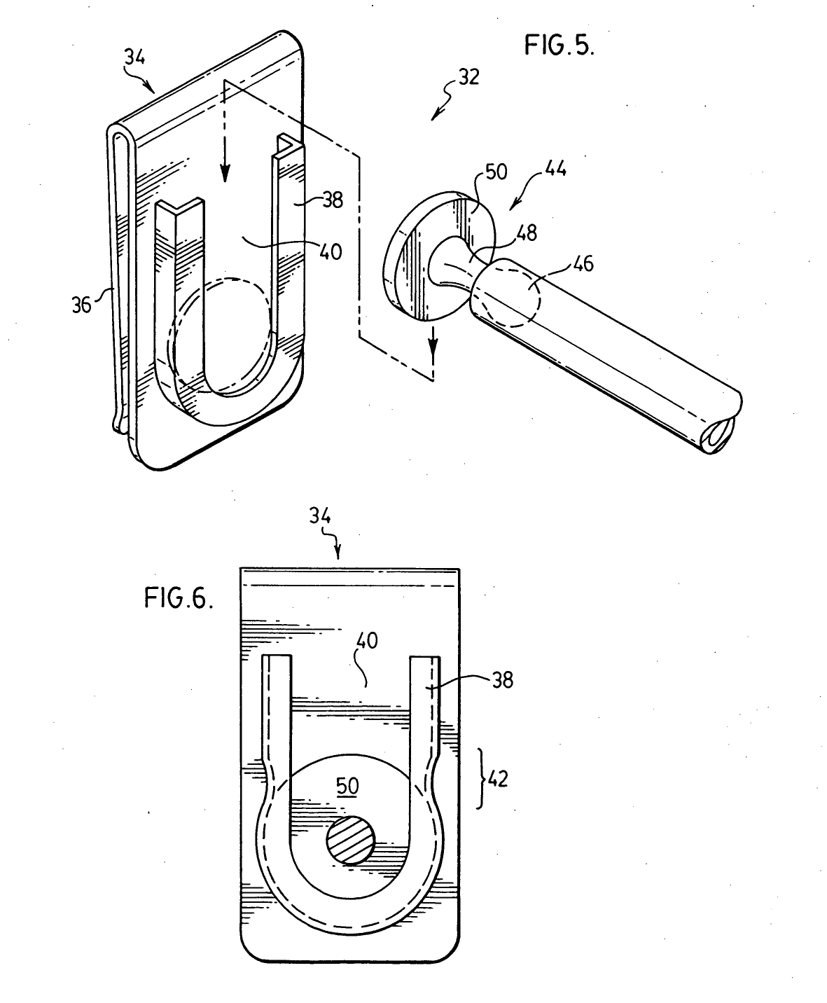

FIG. 5 is a perspective view of a user-side portion 34 and a shaft-side portion 44 of user-releasable coupler 32. User-side portion includes a clip 36 for attaching to a user's clothing (e.g., shorts, pants, belt etc.) and a dock 38. Dock 38 generally consists of a framework that forms a slot 40. Shaft-side portion 44 of user-releasable coupler 32 includes a ball 46 rotatable within and retained by proximal end of tube portion 18, and a post 48 extending from ball 46. Post 46 terminates in a disk 50 whose plane is perpendicular to the main axis of post 48. Disk 50 has a greater diameter than post 48 for use in coupling shaft-side portion 44 of user-releasable coupler 32 to user-side portion of user-releasable coupler 32.

In order to releasably couple shaft-side portion 44 with user-side portion 34, disk 50 is slid into slot 40 of dock 38 from above, until it rests at the bottom of the slot in a position shown by the dashed lines representing disk 50 in its resting location.

FIG. 6 is an elevational view of the user-side portion of the user-releasable coupler. A narrow portion 42 of slot 40 is slightly smaller in width than the diameter of disk 50, such that disk 50 is releasably retained in its resting position in slot 40. When disk 50 and dock 38 are made of resilient plastic, a user pressing down on disk 50 when in slot 40 will cause it to “click” past narrow portion 42 by virtue of narrow portion 42 and/or disk 50 temporarily deforming under pressure. Once disk 50 is in its resting position, disk 50 and/or dock 38 resume their natural form as shown in FIG. 6, so as to retain disk 50 within dock 38. When the user forces disk 50 upwards, disk 50 and/or dock 38 are once again temporarily deformed until disk 50 is above narrow portion 42. The user can then slide disk 50 out of slot 40.

The above provides a very useful device for towing a golf trolley or the like, which is user-releasable both from the trolley and the user. However, alternatives are possible without departing from the spirit and scope of the invention.

For example, according to some embodiments, the shaft would not be adjustable in length. Alternatively, the shaft could be adjustable in length using additional mating extension pieces rather than the ball-bearing spring lock scheme described above.

Furthermore, clamping of handle 6 could be provided by other clamping devices, including those that generally enable only clamping and release positions, with no intermediate positions.

The progressive nature of clamping provided by the collar and split-shaft arrangement could be achieved using means other than cooperating threads. For example, a small rubber band or the like could receive and be nudged along a flexible split shaft portion 22 to progressively increase or decrease pressure on jaws 24. Alternatively, embodiments employing an adjustable clasp to retain and clamp handle 6 rather than a split shaft configuration could be conceived.

With reference to user-releasable coupler 32, while ball 46 of shaft-side portion 44 permits movement of shaft-side portion 44 relative to shaft 12, a rigid connection could be employed, at the expense of flexibility and some comfort on the part of the user. Alternatively, a single-pin hinge connection between shaft-side portion 44 and shaft 12 could be employed to permit some relative vertical or horizontal movement. In another alternative, relative movement could be provided by user-side portion 34 by permitting dock 50 to move relative to clip 36 in some manner.

Other means of connecting shaft side portion 44 and user-side portion 36 are conceivable, such as a hook on the shaft side portion 44 mating with a loop on the user-side portion 36.

While an embodiment suitable for use with open-ended or closed-ended bent handles has been described, it is within the scope of the invention to include embodiments in which a straight handle is accommodated. While the user-releasable clamp in the embodiment described could conceivably grasp a straight handle, the configuration shown would be improved for this purpose if jaws 24 were each split into two slightly spread apart fingers. Jaws 24 in their clamping position would then have a generally diamond shaped opening at their front much like that in their side as best/shown in FIG. 3, and could thereby better accommodate and retain the straight handle also.

It is conceivable that additional accessories such as golf tee clips, a gloves hook and/or an umbrella be attached to shaft 12 in some manner.

Although embodiments have been described, those of skill in the art will appreciate that variations and modifications may be made without departing from the spirit and scope of the invention defined by the appended claims.

What is claimed is:

1. A device for towing a trolley comprising:
a rigid shaft having a proximal end and a distal end;
a user-releasable clamp associated with the distal end, the clamp dimensioned to grip a handle of the trolley; and
a user-releasable coupler associated with the proximal end for coupling the device to a user.

2. The device of claim 1, wherein the shaft has an adjustable length.

3. The device of claim 2, wherein the shaft comprises a rod portion and a tube portion, the rod portion dimensioned to be received by and selectively slidable within the tube portion.

4. The device of claim 3, wherein the rod portion comprises a ball-bearing spring lock movable between a recessed position and a protruding position, the spring lock biased to the protruding position, and further wherein the tube portion comprises a series of holes each dimensioned to receive the spring lock of the rod portion thereby to selectively adjust the length of the shaft.

5. The device of claim 1, wherein the user-releasable clamp is selectively adjustable between a clamping position and a release position.

6. The device of claim 5, wherein the user-releasable clamp is dimensioned to retain the handle when between the clamping position and the release position.

7. The device of claim 1, wherein the user-releasable clamp is dimensioned to grip a trolley handle that runs generally perpendicular to the shaft.

8. The device of claim 1, wherein the user-releasable clamp is dimensioned to grip a trolley handle that is generally aligned with the shaft.

9. The device of claim 1, wherein the user-releasable clamp comprises:
a flexible split shaft portion terminating in a pair of jaws, the jaws dimensioned to cooperatively receive and clamp the handle of the trolley; and
a collar dimensioned to receive the split shaft portion and be movable relative to the split shaft portion to progressively move the jaws between a clamping position and a release position.

10. The device of claim 9, wherein the split shaft portion has external threads dimensioned to mate with internal threads of the collar, wherein rotation of the collar relative to the split shaft portion moves the collar along the shaft via the threads thereby moving the jaws between a clamping position and a release position.

11. The device of claim 1, wherein the user-releasable coupler comprises:
a user-side portion attachable to a user;
a shaft-side portion attached to the shaft and user-releasably retainable by the first portion.

12. The device of claim 11, wherein the user-side portion comprises:
a clip dimensioned to attach to a user's clothing; and
a dock on the clip dimensioned to receive at least part of the shaft-side portion of the user-releasable coupler.

13. The device of claim 12, wherein the shaft-side portion comprises:
a ball retained by and movable relative to the shaft;
a post protruding from the ball; and
a disk on an end of the post opposite the ball portion, the plane of the disk perpendicular to the axis of the post and having a diameter larger than that of the post;
and further wherein the dock comprises a slot for receiving the disk to thereby couple the device to a user.

14. The device of claim 13, wherein the slot has a short narrow portion for selectively retaining the disk within the slot.

15. The device of claim 1, wherein the user-releasable coupler is movable relative to the shaft.
